(19) United States
(12) Patent Application Publication
(10) Pub. No.: US 2015/0030233 A1
(43) Pub. Date: Jan. 29, 2015

(54) System and Method for Determining a Depth Map Sequence for a Two-Dimensional Video Sequence

(71) Applicants: Panos Nasiopoulos, Vancouver (CA); Mahsa Talebpourazad, Vancouver (CA); Ali Bashiashati Saghezchi, Vancouver (CA)

(72) Inventors: Panos Nasiopoulos, Vancouver (CA); Mahsa Talebpourazad, Vancouver (CA); Ali Bashiashati Saghezchi, Vancouver (CA)

(73) Assignee: The University of British Columbia, Vancouver, BC (CA)

(21) Appl. No.: 14/365,039

(22) PCT Filed: Dec. 12, 2011
(86) PCT No.: PCT/CA11/01360

§ 371 Date: Oct. 3, 2014

(51) Int. Cl. G06T 7/00; H04N 13/02

(52) U.S. Cl. CPC G06T 7/0065; H04N 13/0271; H04N 2213/003; G06T 2207/10016; G06T 2207/20021; G06T 2207/20081
USPC 382/154

(57) ABSTRACT

A system and method of determining a depth map sequence for a subject two-dimensional video sequence by: determining a plurality of monocular depth cues for each frame of the subject two-dimensional video sequence; and determining a depth map for each frame of the subject two-dimensional video sequence based on the application of the plurality of monocular depth cues determined for the frame to a depth map model. The depth map model determined by: determining a plurality of monocular depth cues for one or more training two-dimensional video sequences; and determining a depth map model based the plurality of monocular depth cues of the one or more training two-dimensional video sequences and corresponding known depth maps for each of the one or more training two-dimensional video sequences.

### FIELD

The present disclosure generally relates a system and method for determining a depth map sequence for a two-dimensional video sequence.

### BACKGROUND

The mass commercialization of three-dimensional (3D) display technology has increased demand for 3D video content. However, the vast majority of existing content has been created in a two-dimensional (2D) video format. This has led to the development of 2D-to-3D video conversion technologies. These technologies have been typically designed based on the human visual depth perception mechanism which consists of several different depth cues that are applied depending on the context.

Some of these technologies have failed to provide accurate or consistent 2D-3D conversions in all contexts. For example, some of these technologies have overly focused on a single depth cue, failed to adequately account for static images, or failed to properly account for the interdependency amongst various depth cues.

### SUMMARY

According to one aspect of the present disclosure, there is provided a method of determining a depth map sequence for a subject two-dimensional video sequence, the depth map sequence comprising a depth map for each frame of the subject two-dimensional video, the method comprising:
(a) determining a plurality of monocular depth cues for each frame of the subject two-dimensional video sequence;
(b) determining a depth map for each frame of the subject two-dimensional video sequence based on the application of the plurality of monocular depth cues determined for the frame to a depth map model, the depth map model determined by:
   (i) determining a plurality of monocular depth cues for one or more training two-dimensional video sequences; and
   (ii) determining a depth map model based the plurality of monocular depth cues of the one or more training two-dimensional video sequences and corresponding known depth maps for each of the one or more training two-dimensional video sequences.

The depth map model may be determined based on the application of a learning method to the known depth maps and the plurality of monocular depth cues of the one or more training two-dimensional video sequences. The learning method may be a discriminative learning method. For example, the learning method may be a Random Forests machine learning method.

The determination of the plurality of monocular depth cues for the one or more training two-dimensional video sequences may comprise:
(a) selecting training frames from the frames of the one or more training two-dimensional video sequences; and
(b) determining a plurality of monocular depth cues for each training frame.

The determination of the plurality of monocular depth cues for the one or more training two-dimensional video sequences may also comprise:
(a) selecting training frames from the frames of the one or more training two-dimensional video sequences;
(b) selecting one or more blocks from each training frame, each block comprising one or more pixels; and
(c) determining a plurality of monocular depth cues for each of the selected blocks.

The selection of one or more blocks from each training frame may comprise:
(a) dividing the selected frame into an array of blocks;
(b) selecting one or more training blocks from the array of blocks; and
(c) for each training block, selecting one or more enlarged blocks comprising the training block and blocks from the array of blocks that are located within a desired radius from the training block.

The selection of one or more enlarged blocks may comprise:
(a) selecting a first enlarged block comprising the training block and blocks from the array of blocks that are located within a one block radius from the training block; and
(b) selecting a second enlarged block comprising the training block and blocks from the array of blocks that are located within a two block radius from the training block.

The training blocks may comprise blocks from the array of blocks wherein the majority of the pixels in the block depict a single object. The selected frames may comprise frames wherein a scene changes occurs.

The determination of the plurality of monocular depth cues for each frame in the subject two-dimensional video sequence may comprise:
(a) dividing the frame into an array of blocks; and
(b) determining the plurality of monocular depth cues for each of block of the array of blocks.

The determination of the plurality of monocular depth cues for each frame in the subject two-dimensional video sequence may comprise:
(a) dividing the frame into an array of blocks;
(b) for each block in the array of blocks, selecting one or more enlarged blocks comprising the block and blocks from the array of blocks that are located within a desired radius from the block; and
(c) determining the plurality of monocular depth cues for each block and one or more enlarged blocks associated with each block.

The selection of one or more enlarged blocks comprising the block and blocks from the array of blocks that are located within a desired radius from the block may comprise:
(a) selecting a first enlarged block comprising the block and blocks from the array of blocks that are located within a one block radius from the block; and
(b) selecting a second enlarged block comprising the block and blocks from the array of blocks that are located within a two block radius from the block.

The method may further comprise applying spatial consistency signal conditioning to the depth maps determined for each frame of the subject two-dimensional video sequence to account for three-dimensional spatial consistency in the depth map sequence.

The spatial consistency signal conditioning may comprise, for each frame of the subject two-dimensional video sequence:
(a) dividing the frame into an array of blocks;
(b) determining edge blocks in the array of blocks comprising object edges;
(c) for each edge block:
   (i) determining which pixels in the edge block relate to an object and which pixels relate to a background;
   (ii) determining blocks in the array of blocks that are neighbouring the edge block that do not comprise object edges;
   (iii) determining pixels in the neighbouring blocks that do not comprise object edges which relate to an object and pixels which relate to a background;
   (iv) determining from the neighbouring blocks that do not comprise object edges, the median depth value in the depth map of pixels relating to an object and the median depth value in the depth map of pixels relating to a background.
   (v) setting the depth value in the depth map of pixels in the edge block relating to an object to the median depth value determined for pixels relating to an object in the neighbouring blocks that do not comprise object edges; and
   (vi) setting the depth value in the depth map of pixels in the edge block relating to a background to the median depth value determined for pixels relating to a background in the neighbouring blocks that do not comprise object edges.

The pixels in each edge block and corresponding neighbouring blocks that do not comprise object edges may be determined to relate to an object or a background based on colour information, texture information and variance in the depth map for each edge block or corresponding neighbouring blocks that do not comprise object edges.

The method may further comprise applying temporal consistency signal conditioning to the depth maps determined for each frame of the subject two-dimensional video sequence to account for three-dimensional temporal consistency in the depth map sequence.

The spatial consistency signal conditioning may comprise, for each frame of the subject two-dimensional video sequence:
(a) dividing each of the frame, a previous frame and a next frame in the subject two-dimensional sequence into an array of corresponding blocks;
(b) determining static blocks in the array of blocks for the frame, the previous frame and the next frame;
(c) applying a median filter to the depth map of each static block in the frame having a corresponding static block in the previous frame and next frame, based upon the depth map of the corresponding static blocks in each of the frame, previous frame and next frame.

The static blocks in the array of blocks for the frame, the previous frame and the next frame may be determined based on changes in luma information of each block in the array of blocks between successive frames.

The plurality of monocular depth cues may be selected from the group comprising: motion parallax, texture variation, haze, edge information, vertical spatial coordinate, sharpness, and occlusion.

The method may further comprise displaying a 3D video sequence on a display based on the subject two-dimensional video sequence and the depth map sequence.

According to another aspect of the present disclosure, there is provided a method of determining a depth map model for determining a depth map sequence for a subject two-dimensional video sequence, the depth map sequence comprising a depth map for each frame of the subject two-dimensional video, the method comprising:
(a) determining a plurality of monocular depth cues for one or more training two-dimensional video sequences; and
(b) determining the depth map model based the plurality of monocular depth cues of the one or more training two-dimensional video sequences and corresponding known depth maps for each of the one or more training two-dimensional video sequences.

The depth map model may be determined based on the application of a learning method to the known depth maps and the plurality of monocular depth cues of the one or more training two-dimensional video sequences. The learning method may be a discriminative learning method. For example, the learning method may be a Random Forests machine learning method.

The determination of the plurality of monocular depth cues for the one or more training two-dimensional video sequences may comprise:
(a) selecting training frames from the frames of the one or more training two-dimensional video sequences; and
(b) determining a plurality of monocular depth cues for each training frame.

The determination of the plurality of monocular depth cues for the one or more training two-dimensional video sequences may also comprise:
(a) selecting training frames from the frames of the one or more training two-dimensional video sequences;
(b) selecting one or more blocks from each training frame, each block comprising one or more pixels; and
(c) determining a plurality of monocular depth cues for each of the selected blocks.

The selection of one or more blocks from each training frame may comprise:
(a) dividing the selected frame into an array of blocks;
(b) selecting one or more training blocks from the array of blocks; and
(c) for each training block, selecting one or more enlarged blocks comprising the training block and blocks from the array of blocks that are located within a desired radius from the training block.

The selection of one or more enlarged blocks may comprise:
(a) selecting a first enlarged block comprising the training block and blocks from the array of blocks that are located within a one block radius from the training block; and
(b) selecting a second enlarged block comprising the training block and blocks from the array of blocks that are located within a two block radius from the training block.

The training blocks may comprise blocks from the array of blocks wherein the majority of the pixels in the block depict a single object. The selected frames may comprise frames wherein a scene changes occurs.

The plurality of monocular depth cues may be selected from the group comprising: motion parallax, texture variation, haze, edge information, vertical spatial coordinate, sharpness, and occlusion.

According to another aspect of the present disclosure, there is provided a system for determining a depth map sequence for a subject two-dimensional video sequence, the depth map sequence comprising a depth map for each frame of the subject two-dimensional video, the system comprising:
(a) a processor; and
(b) a memory having statements and instructions stored thereon for execution by the processor to:
   (i) determine a plurality of monocular depth cues for each frame of the subject two-dimensional video sequence;
   (ii) determine a depth map for each frame of the subject two-dimensional video sequence based on the application of the plurality of monocular depth cues determined for the frame to a depth map model, the depth map model determined by:
      (1) determine a plurality of monocular depth cues for one or more training two-dimensional video sequences; and
      (2) determine a depth map model based the plurality of monocular depth cues of the one or more training two-dimensional video sequences and corresponding known depth maps for each of the one or more training two-dimensional video sequences.

The depth map model may be determined based on the application of a learning method to the known depth maps and the plurality of monocular depth cues of the one or more training two-dimensional video sequences. The learning method may be a discriminative learning method. For example, the learning method may be a Random Forests machine learning method.

The determination of the plurality of monocular depth cues for the one or more training two-dimensional video sequences may comprise:
(a) selecting training frames from the frames of the one or more training two-dimensional video sequences; and
(b) determining a plurality of monocular depth cues for each training frame.

The determination of the plurality of monocular depth cues for the one or more training two-dimensional video sequences may also comprise:
(a) selecting training frames from the frames of the one or more training two-dimensional video sequences;
(b) selecting one or more blocks from each training frame, each block comprising one or more pixels; and
(c) determining a plurality of monocular depth cues for each of the selected blocks.

The selection of one or more blocks from each training frame may comprise:
(a) dividing the selected frame into an array of blocks;
(b) selecting one or more training blocks from the array of blocks; and
(c) for each training block, selecting one or more enlarged blocks comprising the training block and blocks from the array of blocks that are located within a desired radius from the training block.

The selecting one or more enlarged blocks may comprise:
(a) selecting a first enlarged block comprising the training block and blocks from the array of blocks that are located within a one block radius from the training block; and
(b) selecting a second enlarged block comprising the training block and blocks from the array of blocks that are located within a two block radius from the training block.

The training blocks may comprise blocks from the array of blocks wherein the majority of the pixels in the block depict a single object. The selected frames may comprise frames wherein a scene changes occurs.

The determination of the plurality of monocular depth cues for each frame in the subject two-dimensional video sequence may comprise:
(a) dividing the frame into an array of blocks; and
(b) determining the plurality of monocular depth cues for each of block of the array of blocks.

The determination of the plurality of monocular depth cues for each frame in the subject two-dimensional video sequence may comprise:
(a) dividing the frame into an array of blocks;
(b) for each block in the array of blocks, selecting one or more enlarged blocks comprising the block and blocks from the array of blocks that are located within a desired radius from the block; and
(c) determining the plurality of monocular depth cues for each block and one or more enlarged blocks associated with each block.

The selection of one or more enlarged blocks may comprise:
(a) selecting a first enlarged block comprising the block and blocks from the array of blocks that are located within a one block radius from the block; and
(b) selecting a second enlarged block comprising the block and blocks from the array of blocks that are located within a two block radius from the block.

The system may further comprise applying spatial consistency signal conditioning to the depth maps determined for each frame of the subject two-dimensional video sequence to account for three-dimensional spatial consistency in the depth map sequence.

The spatial consistency signal conditioning may comprise, for each frame of the subject two-dimensional video sequence:
(a) dividing the frame into an array of blocks;
(b) determining edge blocks in the array of blocks comprising object edges;
(c) for each edge block:
   (i) determining which pixels in the edge block relate to an object and which pixels relate to a background;
   (ii) determining blocks in the array of blocks that are neighbouring the edge block that do not comprise object edges;
   (iii) determining pixels in the neighbouring blocks that do not comprise object edges which relate to an object and pixels which relate to a background;
   (iv) determining from the neighbouring blocks that do not comprise object edges, the median depth value in the depth map of pixels relating to an object and the median depth value in the depth map of pixels relating to a background.
   (v) setting the depth value in the depth map of pixels in the edge block relating to an object to the median depth value determined for pixels relating to an object in the neighbouring blocks that do not comprise object edges; and
   (vi) setting the depth value in the depth map of pixels in the edge block relating to a background to the median depth value determined for pixels relating to a background in the neighbouring blocks that do not comprise object edges.

The pixels in each edge block and corresponding neighbouring blocks that do not comprise object edges may be determined to relate to an object or a background based on colour information, texture information and variance in the depth map for each edge block or corresponding neighbouring blocks that do not comprise object edges.

The system may further comprise applying temporal consistency signal conditioning to the depth maps determined for each frame of the subject two-dimensional video sequence to account for three-dimensional temporal consistency in the depth map sequence.

The spatial consistency signal conditioning may comprise, for each frame of the subject two-dimensional video sequence:
(a) dividing each of the frame, a previous frame and a next frame in the subject two-dimensional sequence into an array of corresponding blocks;
(b) determining static blocks in the array of blocks for the frame, the previous frame and the next frame;
(c) applying a median filter to the depth map of each static block in the frame having a corresponding static block in the previous frame and next frame, based upon the depth map of the corresponding static blocks in each of the frame, previous frame and next frame.

The static blocks in the array of blocks for the frame, the previous frame and the next frame may be determined based on changes in luma information of each block in the array of blocks between successive frames.

The plurality of monocular depth cues may be selected from the group comprising: motion parallax, texture variation, haze, edge information, vertical spatial coordinate, sharpness, and occlusion.

The system may further comprise a display for displaying a 3D video sequence based on the subject two-dimensional video sequence and depth map sequence.

The system may further comprise a user interface for selecting a subject two-dimensional video sequence.

According to another aspect of the present disclosure, there is provided a system of determining a depth map model for determining a depth map sequence for a subject two-dimensional video sequence, the depth map sequence comprising a depth map for each frame of the subject two-dimensional video, the system comprising
(a) a processor; and
(b) a memory having statements and instructions stored thereon for execution by the processor to:
   (i) determine a plurality of monocular depth cues for one or more training two-dimensional video sequences; and
   (ii) determine the depth map model based the plurality of monocular depth cues of the one or more training two-dimensional video sequences and corresponding known depth maps for each of the one or more training two-dimensional video sequences.

The depth map model may be determined based on the application of a learning method to the known depth maps and the plurality of monocular depth cues of the one or more training two-dimensional video sequences. The learning method may be a discriminative learning method. For example, the learning method may be a Random Forests machine learning method.

The determination of the plurality of monocular depth cues for the one or more training two-dimensional video sequences may comprise:
(a) selecting training frames from the frames of the one or more training two-dimensional video sequences; and
(b) determining a plurality of monocular depth cues for each training frame.

The determination of the plurality of monocular depth cues for the one or more training two-dimensional video sequences may also comprise:
(a) selecting training frames from the frames of the one or more training two-dimensional video sequences;
(b) selecting one or more blocks from each training frame, each block comprising one or more pixels; and
(c) determining a plurality of monocular depth cues for each of the selected blocks.

The selection of one or more blocks from each training frame may comprise:
(a) dividing the selected frame into an array of blocks;
(b) selecting one or more training blocks from the array of blocks; and
(c) for each training block, selecting one or more enlarged blocks comprising the training block and blocks from the array of blocks that are located within a desired radius from the training block.

The selection of one or more enlarged blocks may comprise:
(a) selecting a first enlarged block comprising the training block and blocks from the array of blocks that are located within a one block radius from the training block; and
(b) selecting a second enlarged block comprising the training block and blocks from the array of blocks that are located within a two block radius from the training block.

The training blocks may comprise blocks from the array of blocks wherein the majority of the pixels in the block depict a single object. The selected frames may comprise frames wherein a scene changes occurs.

The plurality of monocular depth cues may be selected from the group comprising: motion parallax, texture variation, haze, edge information, vertical spatial coordinate, sharpness, and occlusion.

The system may further comprise a user interface for selecting one or more training two-dimensional video sequences.

### BRIEF DESCRIPTION OF THE DRAWINGS

FIG. 1 provides a flow diagram of a method of determining a depth map model for determining a depth map sequence for a two-dimensional video sequence according to an embodiment.

FIG. 2 provides a flow diagram of a method of determining a depth map sequence for a two-dimensional video sequence according to an embodiment.

FIG. 3 provides a diagram illustrating the selection of blocks in a frame of a two dimensional video sequence.

FIG. 4 provides a system diagram of a system for determining a depth map model for determining a depth map sequence for a two-dimensional video sequence according to an embodiment.

FIG. 5 provides a system diagram of a system for determining a depth map sequence for a two-dimensional video sequence according to an embodiment.

FIG. 6 provides a flow diagram of a method of performing signal conditioning to a depth map to account for spatial consistency according to an embodiment.

FIG. 7 provides a flow diagram of a method of performing signal conditioning a depth map to account for temporal consistency according to an embodiment.

### DETAILED DESCRIPTION

Human depth perception is based on several different depth cues that are applied depending on the context. The embodiments of the present disclosure describe to systems and methods for determining depth map sequences for two-dimensional (2D) video sequences that are designed to apply to a broad range of contexts by accounting for interdependencies between multiple depth cues that may be present in each context. These depth map sequences can be used in combination with their associated 2D video sequences to produce corresponding three-dimensional (3D) video sequences. The depth map sequences are generated by determining a plurality of monocular depth cues for frames of a 2D video sequence and applying the monocular depth cues to a depth map model. The depth map model is formed by training a learning method with a 2D training video sequence and corresponding known depth map sequence.

Depth Map Model

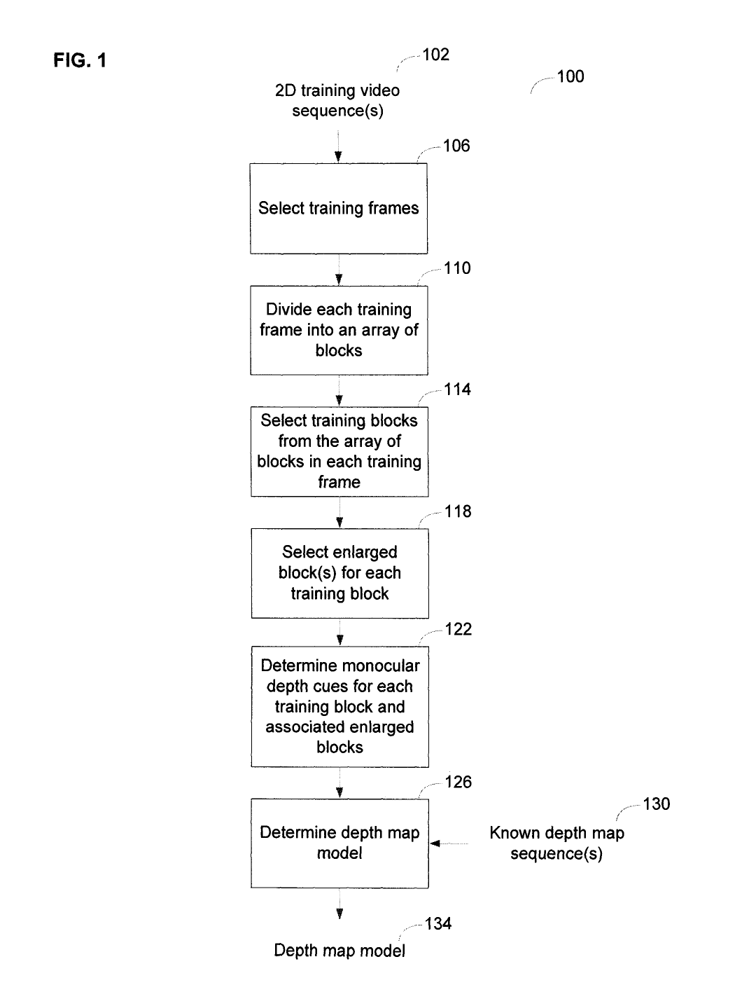

Referring to FIG. 1, a method 100 of determining a depth map model is shown according to one embodiment. The inputs to the method 100 comprise one or more 2D training video sequences 102 and corresponding known depth map sequences 130 for each 2D training video sequence. The output of the method 100 comprises a depth map model 134 which can be used to determine the depth map sequence for a 2D video sequence where the depth map sequence is unknown or unavailable.

Generally, training sequences 102 are selected to provide a broad range of contexts, such as, indoor and outdoor scenes, scenes with different texture and motion complexity, scenes with a variety of content (e.g., sports, news, documentaries, movies, etc.). In alternative embodiments, other suitable types of training sequences 102 may be employed.

In block 106, training frames are selected from the 2D training video sequences 102. In the present embodiment, training frames are selected where scene changes occur, such as, transitions between cuts or frames where there is activity. Generally, it has been found that selecting training frames where scene changes occur tend to provide more useful information (avoiding redundancy in training information) for the purpose of training the depth map model as compared to static frames. In alternative embodiments, other suitable training frames may be selected. In further alternative embodiments, all of the frames of the 2D training video sequences 102 may be selected, including static frames.

In block 110, each training frame is divided into an array of blocks where each block comprises one or more pixels of the training frame. In the present embodiment, the training frame is divided into an array of uniform square blocks. In alternative embodiments, the training frame may be divided into an array of blocks comprising other suitable shapes and sizes.

In block 114, training blocks are then selected from the array of blocks. In the present embodiment, training blocks are selected where the majority of the pixels in the block depict a single object. Generally, it has been found that selecting training blocks where the majority of the pixels in the block depict a single object tends to assist in avoiding depth misperception issues. In the present embodiment, a mean-shift image segmentation method is employed to select training blocks where the majority of the pixels in the block depict a single object (See D. Comaniciu, and P. Meer, “Mean Shift: A Robust Approach toward Feature Space Analysis,” IEEE Trans. Pattern Analysis Machine Intell., vol. 24, no. 5, pp. 603-619, 2002). In alternative embodiments, training blocks where the majority of the pixels in the block depict a single object may be selected manually. In further alternative embodiments, other suitable training blocks may be selected. In yet further alternative embodiments, all of the blocks of a training frame may be selected, including blocks where the majority of the pixels in the block do not depict a single object.

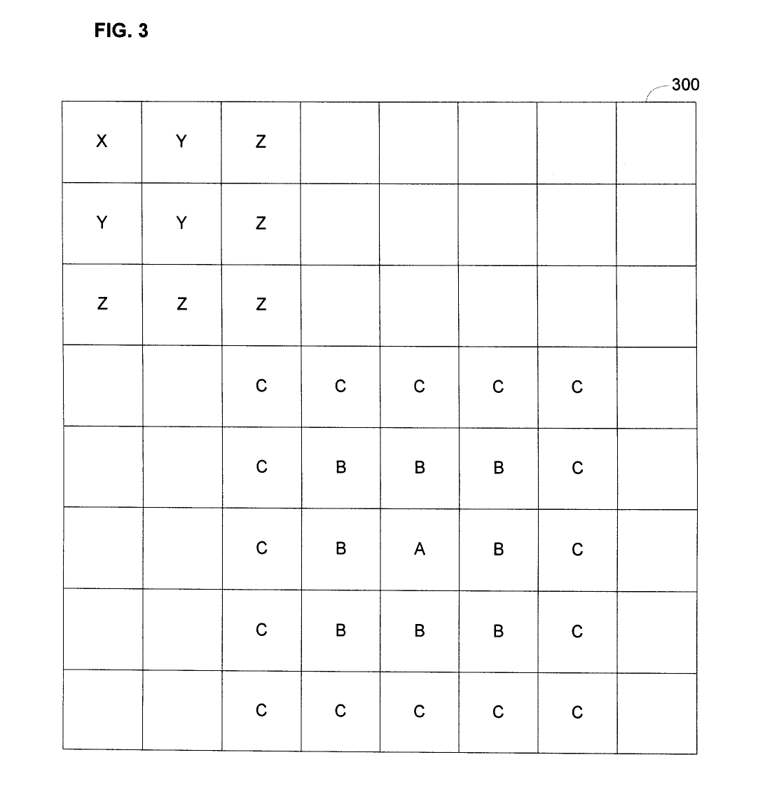

In block 118, for each training block, one or more enlarged blocks are selected. Each enlarged block comprises its corresponding training block and blocks within the array of blocks that are within a desired radius from the training block. The enlarged blocks are selected to provide information to the depth map model 134 respecting portions of the frame neighbouring the training block, such as, the relative depth of neighboured blocks and the identification of occluded regions. In the present embodiment, two enlarged blocks are selected for each training blocks: a first enlarged block comprising the training block and blocks from the array of blocks that are located within a one block radius from the training block, and a second enlarged block comprising the training block and blocks from the array of blocks that are located within a two block radius from the training blocks. In alternative embodiments, enlarged blocks of any suitable shape and size may be employed. Referring to FIG. 3, two training blocks, A and X, are shown with two enlarged blocks selected for each training block A, X. The first enlarged block for training block A comprises training block A and blocks B located within a one block radius from training block A, and the second enlarged block for training block A comprises training block A and blocks B and C located within a two block radius from training block A. Similarly, the first enlarged block for training block X comprises training block X and blocks Y located within a one block radius from training block X, and the second enlarged block for training block X comprises training block X and blocks Y and Z located within a two block radius from training block X.

Referring back to FIG. 1, in block 122, a plurality of monocular depth cues are determined for each training block and the enlarged blocks associated with each training block. In the present embodiment, the monocular depth cues are selected from motion parallax, texture variation, haze, edge information, vertical spatial coordinate, sharpness, and occlusion. A more detailed description of these depth cues is provided below. In alternative embodiments, other suitable monocular depth cues may be employed.

In block 126, the depth map model 134 is determined by training a learning method with inputs comprising the depth cues determined for each training block and associated enlarged blocks, and outputs comprising the known depth maps 130 for each training block and associated enlarged blocks. The trained depth map model 134 may then be used to determine depth map sequences for 2D vide sequences where the depth map sequence is unknown or unavailable.

As discussed above, human depth perception is based on several different depth cues that are applied depending on the context. The learning method is selected and trained such that the depth map model applies to a broad range of contexts by accounting for interdependencies between depth cues that may be present in each context. It has been found that in some cases discriminative learning methods are well suited for this purpose. Discriminative learning methods model the posterior p(y/x) directly, or learn a direct map from inputs x to class labels. In contrast, generative learning methods learn a model of the joint probability, p(x,y), of the inputs a and the label y, and make their predictions by using Bayes' rules to calculate p(y/x), and then picking the most likely label y.

In the present embodiment, the Random Forests (RF) machine learning method (a discriminative learning method) is selected and configured to determine the depth map model. The RF learning method is an ensemble classifier that consists of many decision trees that combines Breiman's “bagging” idea and the random selection of features in order to construct a collection of decision trees with controlled variation. When the training set for the current decision tree is drawn by sampling with replacement, typically, about one-third of the cases are left out of the sample. This out-of-bag (OOB) data can be used to provide a running unbiased estimate of the classification error as trees are added to the forest. The OOB can also be used to provide estimates of variable importance. Thus, when using the RF learning method, typically, there is no requirement for cross-validation or a separate test set to get an unbiased estimate of the test set error. In addition, amongst other advantages, the RF learning method generally learns fast, runs efficiently on large data sets, can handle a large number of input variables without variable deletion, provides an estimation of importance of variables, generates an internal unbiased estimate of the generalization error as the forest building progresses, and does not require a pre-assumption on the distribution of the model as in some other learning methods. These and other features of the RF learning method make the method well suited for estimating depth prediction. For example, the RF learning method may lead to accurate depth maps across a broad range of contexts since the method is designed to learn from conflicts between depth cues and the final depth map model is trained to account for depth cue independencies in a variety of contexts. Amongst other advantages, the ability of the RF learning method to account for the collective contribution and interdependencies of multiple depth cues makes this learning method well suited for addressing scenarios where one or more depth cues does not provide an accurate estimate of the depth map.

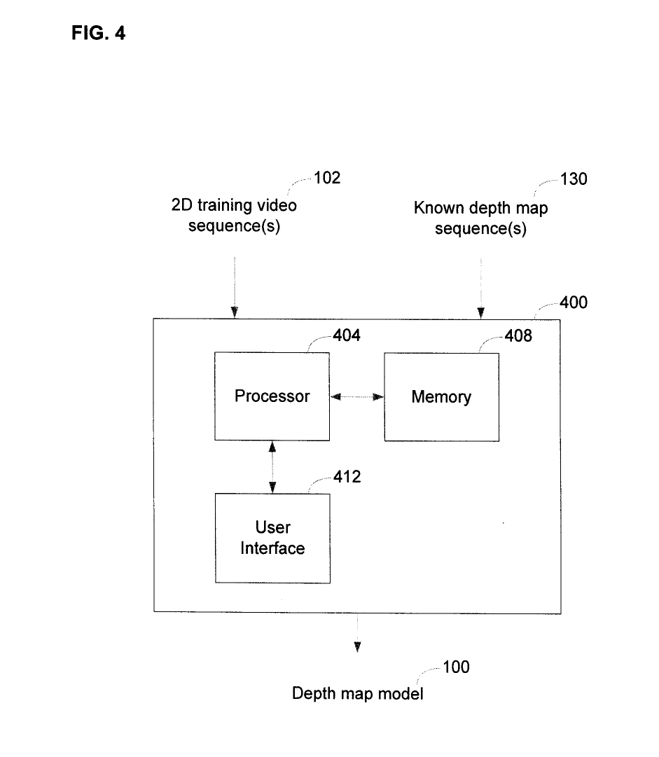

Referring to FIG. 4, a system 400 for determining a depth map model is shown according to one embodiment. The system 400 is configured to determine a depth map model 134 based on one or more 2D training video sequences 102 and corresponding known depth map sequences 130 for each 2D training video sequence, in accordance with method 100 described above. The system 400 generally comprises a processor 404, a memory 408, and a user interface 412. The system 400 may be implemented by one or more servers, computers or electronic devices located at one or more locations communicating through one or more networks.

The memory 408 comprises a computer readable medium comprising (a) instructions stored therein that when executed by the processor 404 perform method 100, and (b) a storage space that may be used by the processor 404 in the performance of method 100. The memory 408 may comprise one or more computer readable mediums located at one more locations communicating through one or more networks, including without limitation, random access memory, flash memory, read only memory, hard disc drives, optical drives and optical drive media, flash drives, and other suitable computer readable storage media known to one skilled in the art.

The processor 404 is configured to perform method 100 to determine a depth map model 134 based on the 2D training video sequences 102 and corresponding known depth map sequences 130. The processor 404 may comprise one or more processors located at one more locations communicating through one or more networks, including without limitation, application specific circuits, programmable logic controllers, field programmable gate arrays, microcontrollers, microprocessors, virtual machines, electronic circuits and suitable other processing devices known to one skilled in the art.

The user interface 412 functions to permit a user to provide information to and receive information from the processor 404 as required to perform the method 100. The user interface 412 may be used by a user to perform any selection described in method 100, such as, for example, selecting 2D training video sequences 102 and frames and blocks within the 2D training video sequences 102, dividing training frames into an array of blocks, or select training frames, training blocks or enlarged blocks. The user interface 412 may comprise one or more suitable user interface devices, such as, for example, keyboards, mice, touch screens displays, or any other suitable devices for permitting a user to provide information to or receive information from the processor 404. In alternative embodiments, the system 400 may not comprise a user interface 412.

Depth Map Sequence Determination

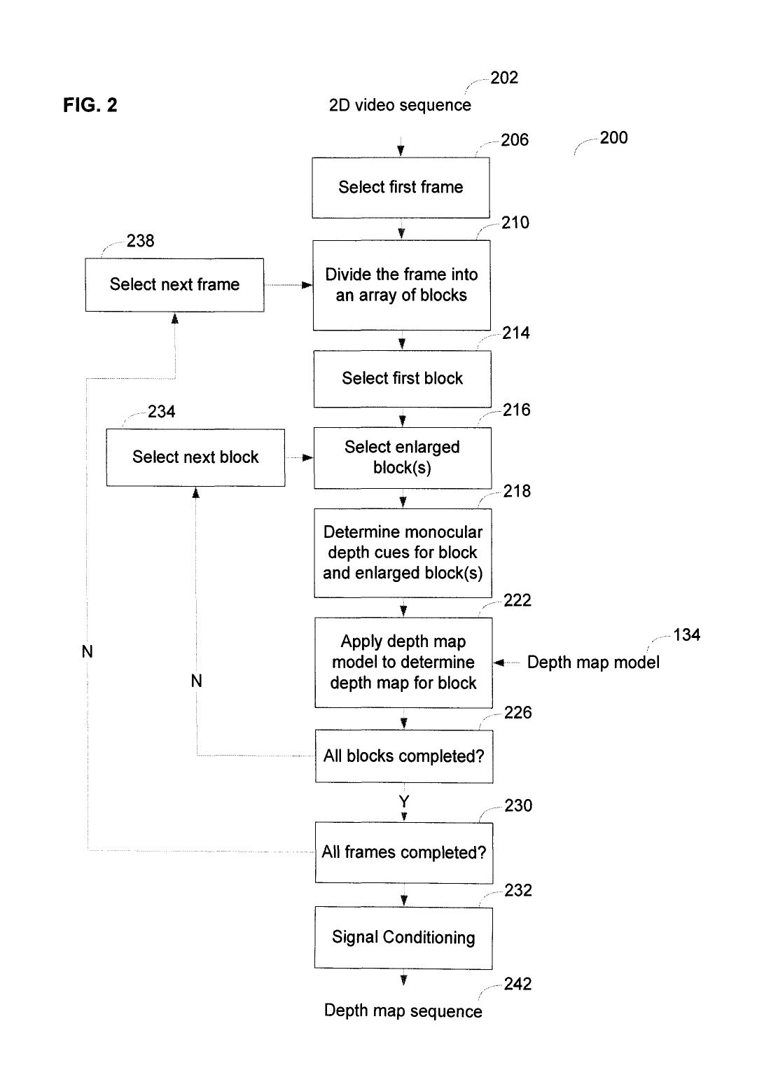

Referring to FIG. 2, a method 200 of determining a depth map sequence for a 2D video sequence is shown according to one embodiment. The inputs to the method 200 comprise a 2D video sequence 202 for which a corresponding depth map sequence is unknown or unavailable, and the depth map model 134 determined in accordance with method 100. The output to the method 200 comprises a depth map sequence 242 for the 2D video sequence 202.

In block 206, the first frame in the 2D video sequence 202 is selected. In block 210, the selected frame is divided into an array of blocks where each block comprises one or more pixels of the frame. The frame is divided such that each block comprises the same shape and the same distribution of pixels as the blocks selected for method 100. In cases where the 2D video sequence 202 has a higher or lower resolution than the 2D video sequences used to train the depth map model 134 in method 100, the pixels in each block of the 2D video sequence 202 can be up-scaled or down-scaled accordingly such that they comprise the same number and distribution of pixels as the blocks selected in method 100. In the present embodiment, the frame is divided into an array of uniform square blocks. In alternative embodiments, the frame may be divided into an array of blocks comprising other suitable shapes and sizes.

In block 214, the first block in the frame is selected. In block 218, one or more enlarged blocks are selected. Each enlarged block comprises its corresponding block and blocks within the array of blocks that are within a desired radius from the block. Enlarged blocks are selected to comprise the same shape and the same distribution of pixels as the enlarged blocks selected for method 100. In cases where the 2D video sequence 202 has a higher or lower resolution than the 2D video sequences used to train the depth map model 134 in method 100, the pixels in each enlarged block of the 2D video sequence 202 can be up-scaled or down-scaled accordingly such that they comprise the same number and distribution of pixels as the enlarged blocks selected in method 100. In the present embodiment, two enlarged blocks are selected for each block in the same manner as enlarged blocks are selected in method 100 and with reference to FIG. 3 Namely, a first enlarged block is selected comprising the block and blocks from the array of blocks that are located within a one block radius from the block, and a second enlarged block is selected comprising the block and blocks from the array of blocks that are located within a two block radius from the block. In alternative embodiments, enlarged blocks of any suitable shape and size may be employed.

In block 218, a plurality of monocular depth cues are determined for the block and enlarged blocks associated with the block. The same monocular depth cues employed in method 100 for determination of the depth map model 134 are determined for the block and enlarged blocks. In the present embodiment, the monocular depth cues are selected from motion parallax, texture variation, haze, edge information, vertical spatial coordinate, sharpness, and occlusion. A more detailed description of these depth cues is provided below. In alternative embodiments, other suitable monocular depth cues may be employed.

In block 222, monocular depth cues determined for the block and enlarged block are applied to the depth map model 134 determined in accordance with method 100, providing a depth map for the block.

In block 226, it is determined if depth maps for all of the blocks of the frame have been determined. If so, all of the depth maps of all of the blocks of the frame are combined to form a depth map for the entire frame and then the method 200 proceeds to block 230. Otherwise, the method 200 proceeds to block 234 where the next block in the frame for which a depth map has not been determined is selected and blocks 216 to 226 are repeated for the next block.

In block 230, it is determined if depth maps for all of the frames in the 2D video sequence 202 have been determined. If so, all of the depth maps of all of the frames are combined to form a depth map sequence for the 2D video sequence 202. Otherwise, the method 200 proceeds to block 238 where the next frame in the 2D video sequence 202 for which a depth map has not been determined is selected and blocks 210 to 230 are repeated for the next frame.

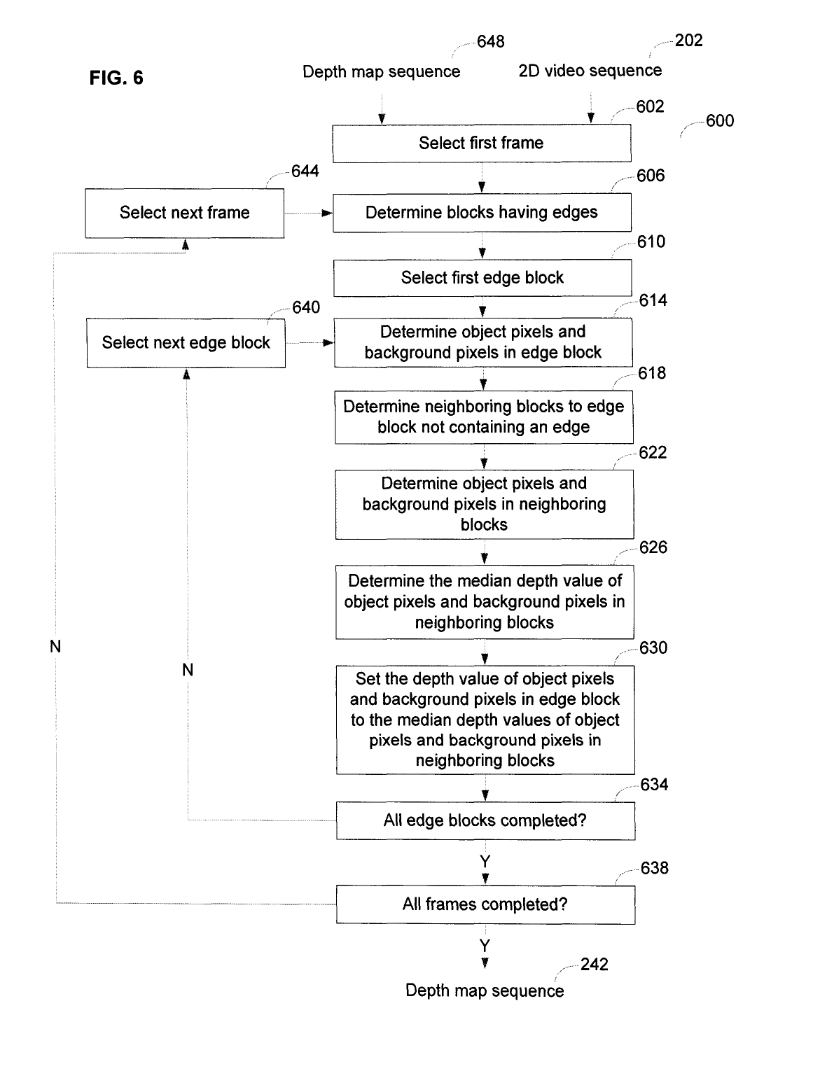

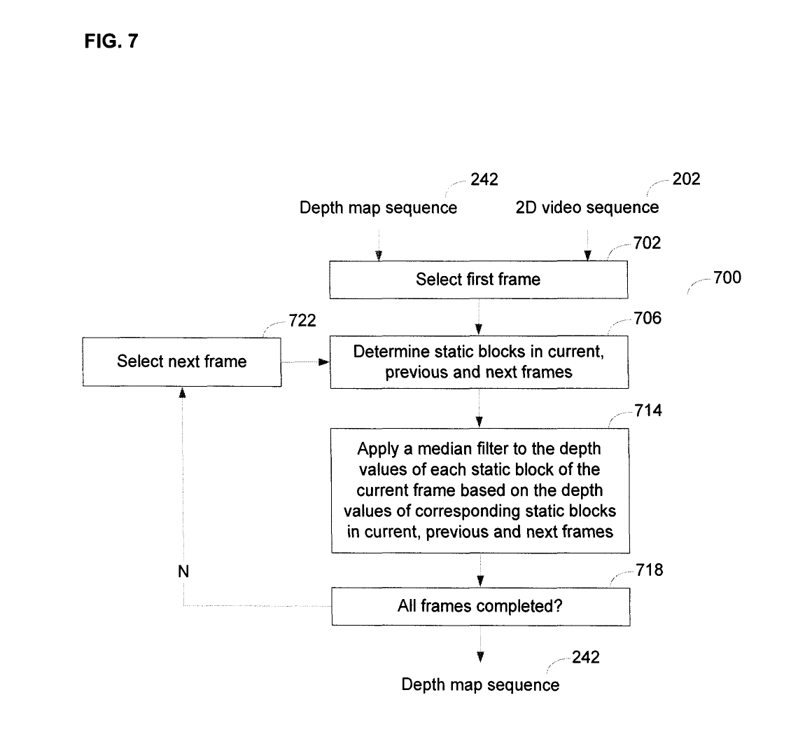

In block 232, desired signal conditioning is applied to the depth map sequence formed in block 230. In the present embodiment, signal conditioning is applied to the depth map sequence to account for spatial consistency and temporal consistency between frames of the depth map sequence, as further described below with reference to FIGS. 6 and 7. After application of desired signal conditioning, the final depth map sequence 242 is formed. In alternative embodiments, signal conditioning is not applied to the depth map sequence formed in block 230.

Referring to FIG. 6, a signal conditioning method 600 is provided for accounting for spatial consistency in the depth map sequence. The inputs to the method 600 comprise a 2D video sequence 202 for which a corresponding depth map sequence is unknown or unavailable, and the unconditioned depth map sequence formed in block 230 of method 200. The output to the method 600 comprises a conditioned depth map sequence 242 for the 2D video sequence 202.

In block 602, a first frame in the 2D video sequence 202 is selected. In block 606, the blocks in the frame (as divided into an array of blocks in accordance with methods 100 and 200) that contain edges (“edge blocks”) are determined based upon the edge information depth cue information determined in method 200 for the blocks of each frame of the 2D video sequence 202.

In block 610, a first block from the edge blocks is selected. In block 614, the pixels of the current edge block are categorized as relating to an object(s) or background. In the present embodiment, pixels are categorized as relating to an object or background using a mean-shift image segmentation method (See D. Comaniciu, and P. Meer, “Mean Shift: A Robust Approach toward Feature Space Analysis,” IEEE Trans. Pattern Analysis Machine Intell., vol. 24, no. 5, pp. 603-619, 2002). In alternative embodiments, other suitable methods of categorizing pixels as relating to an object(s) or background may be employed.

In block 618, blocks that are adjacent to the current edge block that are not edge blocks are identified (i.e. adjacent blocks that do not contain edges). In block 622, the pixels of the each adjacent non-edge block are categorized as relating to an object(s) or background. In the present embodiment, pixels are categorized as relating to an object or background using mean-shift image segmentation method (See D. Comaniciu, and P. Meer, “Mean Shift: A Robust Approach toward Feature Space Analysis,” IEEE Trans. Pattern Analysis Machine Intell., vol. 24, no. 5, pp. 603-619, 2002). In alternative embodiments, other suitable methods of categorizing pixels as relating to an object(s) or background may be employed.

In block 626, the median depth value of the object pixels and background pixels for each adjacent non-edge block are determined. In block 630, the depth value of the object pixels in the current edge block are set to the median depth value of the object pixels in adjacent non-edge blocks, and the depth value of the background pixels in the current edge block are set to the median depth value of the background pixels in adjacent non-edge blocks.

In block 634, it is determined if spatial consistency signal conditioning has been applied to the depth map for all of the edge blocks in the current frame of the 2D video sequence 202. If so, the method 600 proceeds to block 638. Otherwise, the method 600 proceeds to block 640 where the next edge block in the frame is selected for which spatial consistency signal conditioning has not been applied to the depth map is selected and blocks 614 to 634 are repeated for the next edge block.

In block 638, it is determined if spatial consistency signal conditioning has been applied to the depth map for all of the frames in the 2D video sequence 202. If so, the method 600 is complete and a spatial consistency conditioned depth map sequence 242 is provided. Otherwise, the method 600 proceeds to block 644 where the next frame in the 2D video sequence 202 for which spatial consistency signal conditioning has not been applied to the depth map is selected and blocks 606 to 638 are repeated for the next frame.

Referring to FIG. 7, a signal conditioning method 700 is provided for accounting for temporal consistency in the depth map sequence. Method 700 may form the only signal conditioning method applied to a depth map sequence or may be applied to a depth map sequence in combination with other signal conditioning methods. In the present embodiment, signal conditioning method 700 is applied to the depth map sequence provided in method 200 after application of signal conditioning method 600.

The inputs to the method 700 comprise a 2D video sequence 202 for which a corresponding depth map sequence is unknown or unavailable, and the unconditioned depth map sequence formed in block 230 of method 200. The output to the method 700 comprises a conditioned depth map sequence 242 for the 2D video sequence 202.

In block 702, a first frame in the 2D video sequence 202 is selected. In block 706, the blocks in the current, previous and next frames (as divided into an array of blocks in accordance with methods 100 and 200) where objects are static (“static blocks”) are determined. The static blocks are determined by taking into account motion information between frames of the 2D video sequence. In the present embodiment, static blocks are identified by determining a “residue frame” comprising the difference between luma information of corresponding blocks in a frame and its previous frame. Typically, the edge of a moving object in a residue frame appears thicker, with higher density compared to static objects and background in the residue frame. If the variance of edge of an object in a block in the residue frame is less than a predefined threshold, it is determined that the block is a static block. In alternative embodiments, other suitable methods of identifying static block may be employed.

In block 714, a 3D median filter is applied to the depth values of the pixels in each static block of the current frame identified in block 710 based upon the depth values of pixels in corresponding blocks in the current, previous and next frames. It is assumed that depth of static objects should be consistent temporally over consecutive frames. The median filter assists in reducing jitter of edges of the rendered 3D images based on the depth map sequence that may otherwise be present due to temporal inconsistency.

In block 718, it is determined if temporal consistency signal conditioning has been applied to the depth map for all of the frames in the 2D video sequence 202. If so, the method 700 is complete and a temporal consistency conditioned depth map sequence 242 is provided. Otherwise, the method 700 proceeds to block 722 where the next frame in the 2D video sequence 202 for which temporal consistency signal conditioning has not been applied to the depth map is selected and blocks 706 to 718 are repeated for the next frame.

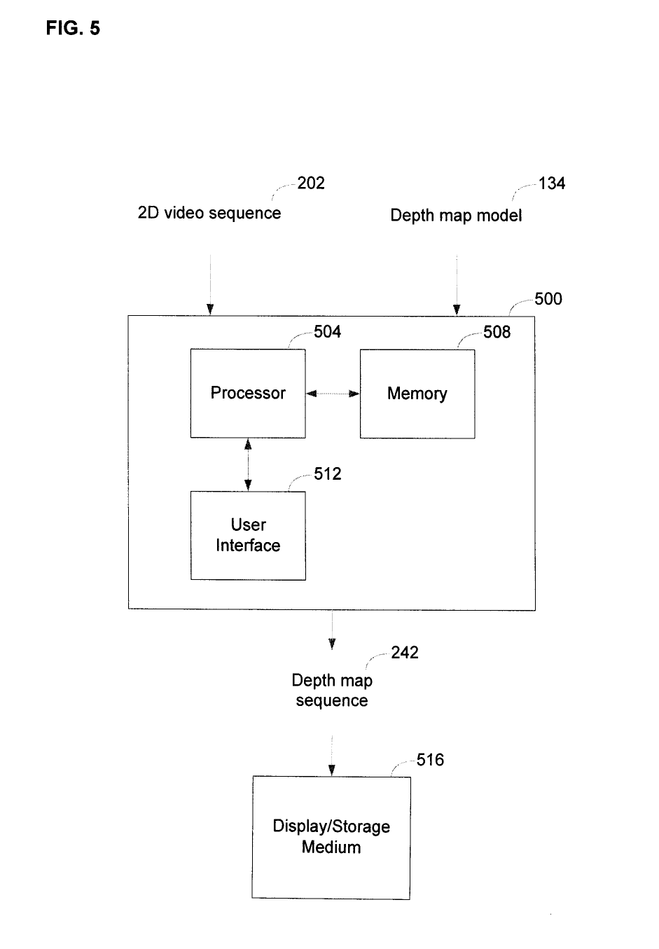

Referring to FIG. 5, a system 500 for determining a depth map sequence for a 2D video sequence is shown according to one embodiment. The system 500 is configured to determine a depth map sequence 242 for a 2D video sequence 202 in accordance with method 200 described above. The system 500 generally comprises a processor 504, a memory 508, and a user interface 512. The system 500 may be implemented by one or more servers, computers or electronic devices located at one or more locations communicating through one or more networks, such as, for example, network servers, personal computers, mobile devices, mobile phones, tablet computers, televisions, displays, set-top boxes, video game devices, DVD players, and other suitable electronic or multimedia devices.

The memory 508 comprises a computer readable medium comprising (a) instructions stored therein that when executed by the processor 504 perform method 200, and (b) a storage space that may be used by the processor 504 in the performance of method 200. The memory 508 may comprise one or more computer readable mediums located at one more locations communicating through one or more networks, including without limitation, random access memory, flash memory, read only memory, hard disc drives, optical drives and optical drive media, flash drives, and other suitable computer readable storage media known to one skilled in the art.

The processor 504 is configured to perform method 200 to determine a depth map sequence 242 for a 2D video sequences 202. The processor 504 may comprise one or more processors located at one more locations communicating through one or more networks, including without limitation, application specific circuits, programmable logic controllers, field programmable gate arrays, microcontrollers, microprocessors, virtual machines, electronic circuits and suitable other processing devices known to one skilled in the art.

The user interface 512 functions to permit a user to provide information to and receive information from the processor 504 as required to perform the method 200. The user interface 512 may comprise one or more suitable user interface devices, such as, for example, keyboards, mice, touch screens displays, or any other suitable devices for permitting a user to provide information to or receive information from the processor 504. In alternative embodiments, the system 500 may not comprise a user interface 512.

The system 500 may also, optionally, comprise a display 516 for displaying 3D video sequence based on the 2D video sequence 202 and depth map sequence 242, or a storage device for storing the 2D video sequence 201 and/or depth map sequence 242. The display may comprise any suitable display for displaying a 3D video sequence, such as, for example, a 3D-enabled television, a 3D-enabled mobile device, and other suitable devices. The storage device may comprise an device suitable for storing the 2D video sequence 202 and/or depth map sequence 242, such as, for example, one or more computer readable mediums located at one more locations communicating through one or more networks, including without limitation, random access memory, flash memory, read only memory, hard disc drives, optical drives and optical drive media, flash drives, and other suitable computer readable storage media known to one skilled in the art.

The system 500 has a number of practical applications, such as, for example, performing real-time 2D-to-3D video sequence conversion on end-user multimedia devices for 2D video sequences with unknown depth map sequences; reducing network bandwidth usage by solely transmitting 2D video sequences to end-user multimedia devices where the depth map sequence is known and performing 2D-3D video sequence conversion on the end-user multimedia device; and other suitable applications.

Depth Cues

Methods 100 and 200 described above make use of multiple depth cues to determine a depth map model and apply the depth map model to 2D video sequences with unknown or unavailable depth map sequences. These depth cues may comprise any suitable depth cue known in the art. In one embodiment, the depth cues are selected from motion parallax, texture variation, haze, edge information, vertical spatial coordinate, sharpness, and occlusion. The following paragraphs introduce these depth cues. In alternative embodiments, other suitable monocular depth cues may be employed.

Motion parallax is a depth cue that takes into account the relative motion between the viewing camera and the observed scene. It is based on the observation that near objects tend move faster across the retina than further objects do. This motion may be seen as a form of “disparity over time”, represented by the concept of motion field. The motion field is the 2D velocity vectors of the image points, introduced by the relative motion between the viewing camera and the observed scene. In one embodiment, motion parallax is determined by employing depth estimation reference software (DERS) recommended by MPEG (See M. Tanimoto, T. Fujii, K. Suzuki, N. Fukushima, and Y. Mori, “Reference Softwares for Depth Estimation and View Synthesis,” ISO/IEC JTC1/SC29/WGl1 MPEG 2008/MI5377, April 2008). DERS is a multi-view depth estimation software which estimates the depth information of a middle view by measuring the disparity that exists between the middle view and its adjacent side views using a block matching method. As applied to frames of a 2D video sequences, there is only one view and the disparity over time is sought rather than the disparity between views. In order to apply DERS for this application, it is assumed that there are three identical cameras in a parallel setup with very small distance between adjacent cameras. The left and right cameras are virtual and the center camera is the one whose recorded video is available. This rearrangement of the existing frames allows DERS to estimate the disparity for the original 2D video over time. The estimated disparity for each block is used as a feature which represents the motion parallax depth cue. In alternative embodiments, other suitable methods of determining the motion parallax depth cue may be employed.

Texture variation is a depth cue that takes into account that the face-texture of a textured material (for example, fabric or wood) is typically more apparent when it is closer to a viewing camera than when it is further away (See L. Lipton, Stereo Graphics Developer's Handbook. Stereo Graphics Corporation, 1991). In one embodiment, Laws' texture energy masks (See K. I. Laws, “Texture energy measures,” Proc. of Image Understanding Workshop, pp. 47-51, 1979) are employed to determine the texture depth cue. Generally, texture information is mostly contained within a frame's luma information. Accordingly, to extract features representing the texture depth-cue, Laws' texture energy masks are applied to the luma information of each block I(x, y) as:

$${E}_{i} = {\sum }_{( x , y ) ∈ {Block}_{i}} {\vert I ( x , y ) * F ( x , y ) \vert}^{k} \\ k = \{ 1 , 2 \} \qquad ( 1 )$$

where F refers to each of the Laws' texture energy masks. As observed from Equation (1), applying each filter mask to the luma component results in two values for Eᵢ: if k=1 then E₁ is equivalent to the sum of the absolute texture energy, and if k=2 then Eᵢ is equal to the sum of squared texture energy. Thus, by applying all 9 of Laws' masks to the luma component of each block using Equation (1), a feature set is obtained that includes 18 features for each block within a frame. In alternative embodiments, other suitable methods of determining the texture depth cue may be employed.

Haze is a depth cue that takes into account atmosphere scattering when the direction and power of the propagation of light through the atmosphere is altered due to a diffusion of radiation by small particles in the atmosphere. As a result, the distant objects visually appear less distinct and more bluish than objects nearby. Haze is generally reflected in the low frequency information of chroma. In one embodiment, extraction of the texture depth cue is achieved by applying the local averaging Laws texture energy filter mask to the chroma components of each block of a frame using Equations (1). This results in a feature set that includes 4 features representing the haze depth cue (two per each color channel of U & V). In alternative embodiments, other suitable methods of determining the haze depth cue may be employed.

Edge information (or perspective) is a depth cue that takes into account that, typically, the more lines that converge, the farther away they appear to be. In one embodiment, the edge information of each frame is derived by applying the Radon Transform to the luma information of each block within the frame. The Radon transform is a method for estimating the density of edges at various orientations. This transform maps the luma information of each block I(x, y) into a new (θ, p) coordinate system, where p corresponds to the density of the edge at each possible orientation of θ. In the present application, θ changes between 0° and 180° with 30° intervals (i.e., θε{0°, 30°, 60°, 90°, 120°, 150°}). Then, the amplitude and phase of the most dominant edge within a block are selected as features representing the block's edge information depth cue. In alternative embodiments, other suitable methods of determining the edge information depth cue may be employed.

Vertical spatial coordinate is a depth cue that takes into account that, typically, video content is recorded such that the objects closer to the bottom boarder of the camera image are closer to the viewer. In one embodiment, the vertical spatial coordinate of each block is represented as a percentage of the frame's height to provide a vertical spatial depth cue. In alternative embodiments, other suitable methods of determining the vertical spatial depth cue may be employed.

Sharpness is a depth cue that takes into account that closer objects tend to appear sharper. In one embodiment, the sharpness of each block is based on the diagonal Laplacian method (See A. Thelen, S. Frey, S. Hirsch, and P. Hering, “Improvements in shape-from-focus for holographic reconstructions with regard to focus operators, neighborhood-size, and height value interpolation”, IEEE Trans. on Image Processing, Vol. 18, no. 1, pp. 151-157, 2009). In alternative embodiments, other suitable methods of determining the sharpness depth cue may be employed.

Occlusion (or intreposition) is a depth cue that takes into account the phenomenon that an object which overlaps or partly obscures the view of another object is typically closer. In one embodiment, a multi-resolution hierarchical approach is implemented to capture the occlusion depth cue (See L. H. Quam, “Hierarchical warp stereo,” In Image Understanding Workshop, pages 149-155, 1984) whereby depth cues are extracted at different image-resolution levels. The difference between depth cues extracted as various resolutions is used to provide information on occlusion. In the present embodiment, occlusion is captured by the selection and determination of depth cues for the enlarged blocks described above in methods 100 and 200. In alternative embodiments, other suitable methods of determining the occlusion depth cue may be employed.

Although the processes illustrated and described herein include series of blocks or steps, it will be appreciated that the different embodiments of the present invention are not limited by the illustrated ordering of blocks or steps, as some blocks or steps may occur in different orders, some concurrently with other blocks or steps apart from that shown and described herein. In addition, not all illustrated blocks or steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

1. A method of determining a depth map sequence for a subject two-dimensional video sequence, the depth map sequence comprising a depth map for each frame of the subject two-dimensional video, the method comprising:
(a) determining a plurality of monocular depth cues for each frame of the subject two-dimensional video sequence;
(b) determining a depth map for each frame of the subject two-dimensional video sequence based on the application of the plurality of monocular depth cues determined for the frame to a depth map model, the depth map model determined by:
(i) determining a plurality of monocular depth cues for one or more training two-dimensional video sequences; and
(ii) determining a depth map model based the plurality of monocular depth cues of the one or more training two-dimensional video sequences and corresponding known depth maps for each of the one or more training two-dimensional video sequences.

2. The method as claimed in claim 1, wherein the depth map model is determined based on the application of a learning method to the known depth maps and the plurality of monocular depth cues of the one or more training two-dimensional video sequences.

3. The method as claimed in claim 2, wherein the learning method is a discriminative learning method.

4. The method as claimed in claim 3, wherein the learning method is a Random Forests machine learning method.

5. The method as claimed in claim 1, wherein determining the plurality of monocular depth cues for the one or more training two-dimensional video sequences comprises:
(a) selecting training frames from the frames of the one or more training two-dimensional video sequences; and
(b) determining a plurality of monocular depth cues for each training frame.

6. The method as claimed in claim 1, wherein determining the plurality of monocular depth cues for the one or more training two-dimensional video sequences comprises:
(a) selecting training frames from the frames of the one or more training two-dimensional video sequences;
(b) selecting one or more blocks from each training frame, each block comprising one or more pixels; and
(c) determining a plurality of monocular depth cues for each of the selected blocks.

7. The method as claimed in claim 6, wherein selecting one or more blocks from each training frame comprises:
(a) dividing the selected frame into an array of blocks;
(b) selecting one or more training blocks from the array of blocks; and
(c) for each training block, selecting one or more enlarged blocks comprising the training block and blocks from the array of blocks that are located within a desired radius from the training block.

8. The method as claimed in claim 7, wherein selecting one or more enlarged blocks comprising the training block and blocks from the array of blocks that are located within a desired radius from the training block comprises:
(a) selecting a first enlarged block comprising the training block and blocks from the array of blocks that are located within a one block radius from the training block; and
(b) selecting a second enlarged block comprising the training block and blocks from the array of blocks that are located within a two block radius from the training block.

9. The method as claimed in claim 7, wherein the training blocks comprise blocks from the array of blocks wherein the majority of the pixels in the block depict a single object.

10. The method as claimed in claim 5, wherein the selected frames comprise frames wherein a scene changes occurs.

11. The method as claimed in claim 1, wherein determining the plurality of monocular depth cues for each frame in the subject two-dimensional video sequence comprises:
(a) dividing the frame into an array of blocks; and
(b) determining the plurality of monocular depth cues for each of block of the array of blocks.

12. The method as claimed in claim 1, wherein determining the plurality of monocular depth cues for each frame in the subject two-dimensional video sequence comprises:
(a) dividing the frame into an array of blocks;
(b) for each block in the array of blocks, selecting one or more enlarged blocks comprising the block and blocks from the array of blocks that are located within a desired radius from the block; and
(c) determining the plurality of monocular depth cues for each block and one or more enlarged blocks associated with each block.

13. The method as claimed in claim 12, wherein selecting one or more enlarged blocks comprising the block and blocks from the array of blocks that are located within a desired radius from the block comprises:
(a) selecting a first enlarged block comprising the block and blocks from the array of blocks that are located within a one block radius from the block; and
(b) selecting a second enlarged block comprising the block and blocks from the array of blocks that are located within a two block radius from the block.

14. The method as claimed in claim 1, wherein the method further comprises applying spatial consistency signal conditioning to the depth maps determined for each frame of the subject two-dimensional video sequence to account for three-dimensional spatial consistency in the depth map sequence.

15. The method as claimed in claim 14, wherein the spatial consistency signal conditioning comprises, for each frame of the subject two-dimensional video sequence:
(a) dividing the frame into an array of blocks;
(b) determining edge blocks in the array of blocks comprising object edges;
(c) for each edge block:
(i) determining which pixels in the edge block relate to an object and which pixels relate to a background;
(ii) determining blocks in the array of blocks that are neighbouring the edge block that do not comprise object edges;
(iii) determining pixels in the neighbouring blocks that do not comprise object edges which relate to an object and pixels which relate to a background;
(iv) determining from the neighbouring blocks that do not comprise object edges, the median depth value in the depth map of pixels relating to an object and the median depth value in the depth map of pixels relating to a background.
(v) setting the depth value in the depth map of pixels in the edge block relating to an object to the median depth value determined for pixels relating to an object in the neighbouring blocks that do not comprise object edges; and
(vi) setting the depth value in the depth map of pixels in the edge block relating to a background to the median depth value determined for pixels relating to a background in the neighbouring blocks that do not comprise object edges.

16. The method as claimed in claim 15, wherein pixels in each edge block and corresponding neighbouring blocks that do not comprise object edges are determined to relate to an object or a background based on colour information, texture information and variance in the depth map for each edge block or corresponding neighbouring blocks that do not comprise object edges.

17. The method as claimed in claim 1, wherein the method further comprises applying temporal consistency signal conditioning to the depth maps determined for each frame of the subject two-dimensional video sequence to account for three-dimensional temporal consistency in the depth map sequence.

18. The method as claimed in claim 16, wherein the spatial consistency signal conditioning comprises, for each frame of the subject two-dimensional video sequence:
(a) dividing each of the frame, a previous frame and a next frame in the subject two-dimensional sequence into an array of corresponding blocks;
(b) determining static blocks in the array of blocks for the frame, the previous frame and the next frame;
(c) applying a median filter to the depth map of each static block in the frame having a corresponding static block in the previous frame and next frame, based upon the depth map of the corresponding static blocks in each of the frame, previous frame and next frame.

19. The method as claimed in claim 18, wherein the static blocks in the array of blocks for the frame, the previous frame and the next frame are determined based on changes in luma information of each block in the array of blocks between successive frames.

20. The method as claimed in claim 1, wherein the plurality of monocular depth cues are selected from the group comprising: motion parallax, texture variation, haze, edge information, vertical spatial coordinate, sharpness, and occlusion.

21. The method as claimed in claim 1, further comprising displaying a 3D video sequence on a display based on the subject two-dimensional video sequence and the depth map sequence.

22. A method of determining a depth map model for determining a depth map sequence for a subject two-dimensional video sequence, the depth map sequence comprising a depth map for each frame of the subject two-dimensional video, the method comprising
(a) determining a plurality of monocular depth cues for one or more training two-dimensional video sequences; and
(b) determining the depth map model based the plurality of monocular depth cues of the one or more training two-dimensional video sequences and corresponding known depth maps for each of the one or more training two-dimensional video sequences.

23. The method as claimed in claim 22, wherein the depth map model is determined based on the application of a learning method to the known depth maps and the plurality of monocular depth cues of the one or more training two-dimensional video sequences.

24. The method as claimed in claim 23, wherein the learning method is a discriminative learning method.

25. The method as claimed in claim 24, wherein the learning method is a Random Forests machine learning method.

26. The method as claimed in claim 22, wherein determining the plurality of monocular depth cues for the one or more training two-dimensional video sequences comprises:
(a) selecting training frames from the frames of the one or more training two-dimensional video sequences; and
(b) determining a plurality of monocular depth cues for each training frame.

27. The method as claimed in claim 22, wherein determining the plurality of monocular depth cues for the one or more training two-dimensional video sequences comprises:
(a) selecting training frames from the frames of the one or more training two-dimensional video sequences;
(b) selecting one or more blocks from each training frame, each block comprising one or more pixels; and
(c) determining a plurality of monocular depth cues for each of the selected blocks.

28. The method as claimed in claim 27, wherein selecting one or more blocks from each training frame comprises:
(a) dividing the selected frame into an array of blocks;
(b) selecting one or more training blocks from the array of blocks; and
(c) for each training block, selecting one or more enlarged blocks comprising the training block and blocks from the array of blocks that are located within a desired radius from the training block.

29. The method as claimed in claim 28, wherein selecting one or more enlarged blocks comprising the training block and blocks from the array of blocks that are located within a desired radius from the training block comprises:
(a) selecting a first enlarged block comprising the training block and blocks from the array of blocks that are located within a one block radius from the training block; and
(b) selecting a second enlarged block comprising the training block and blocks from the array of blocks that are located within a two block radius from the training block.

30. The method as claimed in claim 28, wherein the training blocks comprise blocks from the array of blocks wherein the majority of the pixels in the block depict a single object.

31. The method as claimed in claim 26, wherein the selected frames comprise frames wherein a scene changes occurs.

32. The method as claimed in claim 22, wherein the plurality of monocular depth cues are selected from the group comprising: motion parallax, texture variation, haze, edge information, vertical spatial coordinate, sharpness, and occlusion.

33. A system for determining a depth map sequence for a subject two-dimensional video sequence, the depth map sequence comprising a depth map for each frame of the subject two-dimensional video, the system comprising:
(a) a processor; and
(b) a memory having statements and instructions stored thereon for execution by the processor to:
(i) determine a plurality of monocular depth cues for each frame of the subject two-dimensional video sequence;
(ii) determine a depth map for each frame of the subject two-dimensional video sequence based on the application of the plurality of monocular depth cues determined for the frame to a depth map model, the depth map model determined by:
(1) determine a plurality of monocular depth cues for one or more training two-dimensional video sequences; and
(2) determine a depth map model based the plurality of monocular depth cues of the one or more training two-dimensional video sequences and corresponding known depth maps for each of the one or more training two-dimensional video sequences.

34. The system as claimed in claim 33, wherein the depth map model is determined based on the application of a learning method to the known depth maps and the plurality of monocular depth cues of the one or more training two-dimensional video sequences.

35. The system as claimed in claim 34, wherein the learning method is a discriminative learning method.

36. The system as claimed in claim 35, wherein the learning method is a Random Forests machine learning method.

37. The system as claimed in claim 33, wherein determining the plurality of monocular depth cues for the one or more training two-dimensional video sequences comprises:
(a) selecting training frames from the frames of the one or more training two-dimensional video sequences; and
(b) determining a plurality of monocular depth cues for each training frame.

38. The system as claimed in claim 33, wherein determining the plurality of monocular depth cues for the one or more training two-dimensional video sequences comprises:
(a) selecting training frames from the frames of the one or more training two-dimensional video sequences;
(b) selecting one or more blocks from each training frame, each block comprising one or more pixels; and
(c) determining a plurality of monocular depth cues for each of the selected blocks.

39. The system as claimed in claim 38, wherein selecting one or more blocks from each training frame comprises:
(a) dividing the selected frame into an array of blocks;
(b) selecting one or more training blocks from the array of blocks; and
(c) for each training block, selecting one or more enlarged blocks comprising the training block and blocks from the array of blocks that are located within a desired radius from the training block.

40. The system as claimed in claim 39, wherein selecting one or more enlarged blocks comprising the training block and blocks from the array of blocks that are located within a desired radius from the training block comprises:
(a) selecting a first enlarged block comprising the training block and blocks from the array of blocks that are located within a one block radius from the training block; and
(b) selecting a second enlarged block comprising the training block and blocks from the array of blocks that are located within a two block radius from the training block.

41. The system as claimed in claim 39, wherein the training blocks comprise blocks from the array of blocks wherein the majority of the pixels in the block depict a single object.

42. The system as claimed in claim 37, wherein the selected frames comprise frames wherein a scene changes occurs.

43. The system as claimed in claim 33, wherein determining the plurality of monocular depth cues for each frame in the subject two-dimensional video sequence comprises:
(a) dividing the frame into an array of blocks; and
(b) determining the plurality of monocular depth cues for each of block of the array of blocks.

44. The system as claimed in claim 33, wherein determining the plurality of monocular depth cues for each frame in the subject two-dimensional video sequence comprises:
(a) dividing the frame into an array of blocks;
(b) for each block in the array of blocks, selecting one or more enlarged blocks comprising the block and blocks from the array of blocks that are located within a desired radius from the block; and
(c) determining the plurality of monocular depth cues for each block and one or more enlarged blocks associated with each block.

45. The system as claimed in claim 44, wherein selecting one or more enlarged blocks comprising the block and blocks from the array of blocks that are located within a desired radius from the block comprises:
(a) selecting a first enlarged block comprising the block and blocks from the array of blocks that are located within a one block radius from the block; and
(b) selecting a second enlarged block comprising the block and blocks from the array of blocks that are located within a two block radius from the block.

46. The system as claimed in claim 33, wherein the system further comprises applying spatial consistency signal conditioning to the depth maps determined for each frame of the subject two-dimensional video sequence to account for three-dimensional spatial consistency in the depth map sequence.

47. The system as claimed in claim 47, wherein the spatial consistency signal conditioning comprises, for each frame of the subject two-dimensional video sequence:
(a) dividing the frame into an array of blocks;
(b) determining edge blocks in the array of blocks comprising object edges;
(c) for each edge block:
(i) determining which pixels in the edge block relate to an object and which pixels relate to a background;
(ii) determining blocks in the array of blocks that are neighbouring the edge block that do not comprise object edges;
(iii) determining pixels in the neighbouring blocks that do not comprise object edges which relate to an object and pixels which relate to a background;
(iv) determining from the neighbouring blocks that do not comprise object edges, the median depth value in the depth map of pixels relating to an object and the median depth value in the depth map of pixels relating to a background.
(v) setting the depth value in the depth map of pixels in the edge block relating to an object to the median depth value determined for pixels relating to an object in the neighbouring blocks that do not comprise object edges; and
(vi) setting the depth value in the depth map of pixels in the edge block relating to a background to the median depth value determined for pixels relating to a background in the neighbouring blocks that do not comprise object edges.

48. The system as claimed in claim 47, wherein pixels in each edge block and corresponding neighbouring blocks that do not comprise object edges are determined to relate to an object or a background based on colour information, texture information and variance in the depth map for each edge block or corresponding neighbouring blocks that do not comprise object edges.

49. The system as claimed in claim 33, wherein the system further comprises applying temporal consistency signal conditioning to the depth maps determined for each frame of the subject two-dimensional video sequence to account for three-dimensional temporal consistency in the depth map sequence.

50. The system as claimed in claim 49, wherein the spatial consistency signal conditioning comprises, for each frame of the subject two-dimensional video sequence:
(a) dividing each of the frame, a previous frame and a next frame in the subject two-dimensional sequence into an array of corresponding blocks;
(b) determining static blocks in the array of blocks for the frame, the previous frame and the next frame;
(c) applying a median filter to the depth map of each static block in the frame having a corresponding static block in the previous frame and next frame, based upon the depth map of the corresponding static blocks in each of the frame, previous frame and next frame.

51. The system as claimed in claim 50, wherein the static blocks in the array of blocks for the frame, the previous frame and the next frame are determined based on changes in luma information of each block in the array of blocks between successive frames.

52. The system as claimed in claim 33, wherein the plurality of monocular depth cues are selected from the group comprising: motion parallax, texture variation, haze, edge information, vertical spatial coordinate, sharpness, and occlusion.

53. The system as claimed in claim 33, wherein the system further comprises a display for displaying a 3D video sequence based on the subject two-dimensional video sequence and depth map sequence.

54. The system as claimed in claim 33, wherein the system further comprises a user interface for selecting a subject two-dimensional video sequence.

55. A system of determining a depth map model for determining a depth map sequence for a subject two-dimensional video sequence, the depth map sequence comprising a depth map for each frame of the subject two-dimensional video, the system comprising
(a) a processor; and
(b) a memory having statements and instructions stored thereon for execution by the processor to:
(i) determine a plurality of monocular depth cues for one or more training two-dimensional video sequences; and
(ii) determine the depth map model based the plurality of monocular depth cues of the one or more training two-dimensional video sequences and corresponding known depth maps for each of the one or more training two-dimensional video sequences.

56. The system as claimed in claim 55, wherein the depth map model is determined based on the application of a learning method to the known depth maps and the plurality of monocular depth cues of the one or more training two-dimensional video sequences.

57. The system as claimed in claim 56, wherein the learning method is a discriminative learning method.

58. The system as claimed in claim 57, wherein the learning method is a Random Forests machine learning method.

59. The system as claimed in claim 55, wherein determining the plurality of monocular depth cues for the one or more training two-dimensional video sequences comprises:
(a) selecting training frames from the frames of the one or more training two-dimensional video sequences; and
(b) determining a plurality of monocular depth cues for each training frame.

60. The system as claimed in claim 55, wherein determining the plurality of monocular depth cues for the one or more training two-dimensional video sequences comprises:
(a) selecting training frames from the frames of the one or more training two-dimensional video sequences;
(b) selecting one or more blocks from each training frame, each block comprising one or more pixels; and
(c) determining a plurality of monocular depth cues for each of the selected blocks.

61. The system as claimed in claim 60, wherein selecting one or more blocks from each training frame comprises:
(a) dividing the selected frame into an array of blocks;
(b) selecting one or more training blocks from the array of blocks; and
(c) for each training block, selecting one or more enlarged blocks comprising the training block and blocks from the array of blocks that are located within a desired radius from the training block.

62. The system as claimed in claim 61, wherein selecting one or more enlarged blocks comprising the training block and blocks from the array of blocks that are located within a desired radius from the training block comprises:
(a) selecting a first enlarged block comprising the training block and blocks from the array of blocks that are located within a one block radius from the training block; and
(b) selecting a second enlarged block comprising the training block and blocks from the array of blocks that are located within a two block radius from the training block.

63. The system as claimed in claim 61, wherein the training blocks comprise blocks from the array of blocks wherein the majority of the pixels in the block depict a single object.

64. The system as claimed in claim 59, wherein the selected frames comprise frames wherein a scene changes occurs.

65. The system as claimed in claim 55, wherein the plurality of monocular depth cues are selected from the group comprising: motion parallax, texture variation, haze, edge information, vertical spatial coordinate, sharpness, and occlusion.

66. The system as claimed in claim 55, wherein the system further comprises a user interface for selecting one or more training two-dimensional video sequences.
